(19) United States
(12) Patent Application Publication
(10) Pub. No.: US 2021/0323619 A1
(43) Pub. Date: Oct. 21, 2021

(54) WALL-CLIMBING DRONE USING AUXILIARY ARM AND METHOD FOR CONTROLLING THEREFOR

(71) Applicant: Korea Advanced Institute of Science and Technology, Daejeon (KR)

(72) Inventors: Hyeon Myeong, Daejeon (KR); Wancheol Myeong, Daejeon (KR)

(73) Assignee: Korea Advanced Institute of Science and Technology, Daejeon (KR)

(21) Appl. No.: 17/230,596

(22) Filed: Apr. 14, 2021

(30) Foreign Application Priority Data
Apr. 16, 2020 (KR) 10-2020-0046129
Dec. 9, 2020 (KR) 10-2020-0171195

(51) Int. Cl. B62D 57/024; B62D 57/028; G05D 1/02

(52) U.S. Cl. CPC B62D 57/024; G05D 1/021; B62D 57/028

(57) ABSTRACT

A wall-climbing drone using an auxiliary arm and a method for controlling therefore are disclosed. The wall-climbing drone according to an example of embodiments includes at least one front wheel for moving a drone on a wall by being attached on one surface of a body in contact with the wall and controlling rotation by a wall-climbing motor; an auxiliary arm including a link having one degree of freedom connected to a part of the body and changing an angle and an auxiliary wheel attached to an end of the link; a power transmission system for controlling power transmission by connecting a belt between the body and the auxiliary arm and using the belt; and a controlling unit for controlling propulsion force of each of at least one propellant according to an angle between the auxiliary arm and the body in a state attached to the wall, controlling power transmission of the power transmission system, and controlling movement of the drone by controlling rotation of the motor.

This application claims the priority benefit of Korean Patent Application No. 10-2020-0046129, filed on Apr. 16, 2020, and Korean Application No. 10-2020-0171195, filed on Dec. 09, 2020, in the Korean Intellectual Property Office, the disclosure of which is incorporated herein by reference.

### BACKGROUND

### 1. Field of the Invention

The present invention relates to a wall-climbing drone using an auxiliary arm, and more particularly, relates to a wall-climbing drone using an auxiliary arm which may easily perform attachment of a wall and movement on a wall by controlling a link angle of the auxiliary arm by using the auxiliary arm including a link having one degree of freedom and changing an angle and an auxiliary wheel attached to an end of the link and a front wheel by motor control attached to a body and a method for controlling therefor.

### 2. Description of Related Art

Structural health of large-scale structures such as bridges, high rise buildings, wind turbines, large aircrafts, and ships is directly related to social safety, and recently, social interest in structure safety test is increasing due to deterioration and collapse accidents of large-scale structures. However, the present structure safety test mostly depends on manpower, and there are problems such as manpower supply and demand and danger of an accident since a person directly approaches to a corresponding area to perform the test.

In addition, most of maintenance of solar panels and condition check of aircrafts, which are recently increasing, also depend on manpower, and it has a problem of lack of professional manpower. Since a wall-climbing robot can solve the problem, the need for the wall-climbing robot is on the rise. The wall-climbing robot has several methods according to the development direction, but it can be broadly classified into infrastructure-base and non-infrastructure-base.

In case of an infrastructure-based wall-climbing robot, it has high available payload and stability, but in order to use the corresponding wall-climbing robot, infrastructure such as wires and steel-frame structures must be built in advance, and since it has a disadvantage of time and effort required to build the infrastructure and damaging the beauty of buildings for continuous maintenance, it has not been used. To solve the problem, research on a non-infrastructure-based wall-climbing robot that does not require infrastructure has been done, but such methods have problems such as low payload and stability and limitation of mobility. Recently, the wall-climbing robots using drones with free movement as their strength have been developed, but existing wall-climbing drones are inefficient in energy use when working on a wall, and due to characteristics of the structure, the robots has a large impact and unstable motion when attaching to or detaching from the wall.

Also, such existing methods cannot be used in various forms such as curved and inclined walls, and walls with obstacles such as window frames in many cases.

### SUMMARY

At least one example embodiment provides a wall-climbing drone using an auxiliary arm which may easily perform attachment of a wall and movement on a wall by controlling a link angle of the auxiliary arm by using the auxiliary arm including a link having one degree of freedom and changing an angle and an auxiliary wheel attached to an end of the link and a front wheel by motor control attached to a body and a method for controlling therefor.

A wall-climbing drone according to one example of embodiments includes at least one front wheel for moving a drone on a wall by being attached on one surface of a body in contact with the wall and controlling rotation by a wall-climbing motor; an auxiliary arm including a link having one degree of freedom connected to a part of the body and changing an angle and an auxiliary wheel attached to an end of the link; a power transmission system for controlling power transmission by connecting a belt between the body and the auxiliary arm and using the belt; and a controlling unit for controlling propulsion force of each of at least one propellant according to an angle between the auxiliary arm and the body in a state attached to the wall, controlling power transmission of the power transmission system, and controlling movement of the drone by controlling rotation of the motor.

The power transmission system may include an elastic wire having a certain elasticity connected between a first anchor of the body and the link; a pulley belt connected with the link and moving through a guide pulley formed at a second anchor of the body; and a pulley actuator controlling an angle between the body and the link by controlling movement direction of the pulley belt.

Furthermore, the wall-climbing drone according to one example of embodiments may further include a battery for providing power to the drone, and the battery may maintain balance of the drone by moving its location according to an angle between the auxiliary arm and the body.

The battery may move in a direction toward the front wheel as an angle between the auxiliary arm and the body increases, and move in a direction opposite to the front wheel as an angle between the auxiliary arm and the body decreases.

The battery may be formed on a surface opposite to one surface of the body on which the auxiliary arm is formed, and have a landing wheel for landing the drone when the drone comes down to ground.

The battery may be moved its location by the pulley actuator, provided in the power transmission system, controlling an angle between the body and the auxiliary arm.

A method for controlling a wall-climbing drone according to one example of embodiments includes estimating an angle between at least one front wheel for moving a drone on a wall by being attached on one surface of a body in contact with the wall and controlling rotation by a wall-climbing motor and an auxiliary arm including a link having one degree of freedom connected to a part of the body and changing an angle and an auxiliary wheel attached to an end of the link; controlling propulsion force of each of at least one propellant according to an angle between the auxiliary arm and the body; and controlling an angle between the auxiliary arm and the body by controlling power transmission by connecting a belt between the body and the auxiliary arm and using the belt, and controlling movement of the drone by controlling rotation of the motor.

The controlling movement of the drone may control power transmission by using a power transmission system including an elastic wire having a certain elasticity connected between a first anchor of the body and the link, a pulley belt connected with the link and moving through a guide pulley formed at a second anchor of the body, and a pulley actuator controlling an angle between the body and the link by controlling movement direction of the pulley belt.

Furthermore, the method for controlling a wall-climbing drone according to one example of embodiments may further include maintaining balance of the drone by using a battery whose location is moved according to an angle between the auxiliary arm and the body.

The maintaining balance of the drone may maintain balance of the drone by moving the battery in a direction toward the front wheel as an angle between the auxiliary arm and the body increases and in a direction opposite to the front wheel as an angle between the auxiliary arm and the body decreases.

The maintaining balance of the drone may maintain balance of the drone by moving a location by the pulley actuator, provided in the power transmission system, controlling an angle between the body and the auxiliary arm.

A wall-climbing drone according to another example of embodiments includes at least one front wheel for moving a drone on a wall by being attached on one surface of a body in contact with the wall and controlling rotation by a wall-climbing motor; an auxiliary arm including a link having one degree of freedom connected to a part of the body and changing an angle and an auxiliary wheel attached to an end of the link; a power transmission system for controlling power transmission by connecting a belt between the body and the auxiliary arm and using the belt; a battery for providing power to the drone and maintaining balance of the drone by moving its location according to an angle between the auxiliary arm and the body by moving its location in a direction toward the front wheel as an angle between the auxiliary arm and the body increases and in a direction opposite to the front wheel as an angle between the auxiliary arm and the body decreases; and a controlling unit for controlling propulsion force of each of at least one propellant according to an angle between the auxiliary arm and the body in in a state attached to the wall, controlling power transmission of the power transmission system, and controlling the movement of the drone by controlling rotation of the motor.

According to example embodiments, it may easily perform attachment of a wall and movement on a wall by controlling a link angle of an auxiliary arm by using the auxiliary arm including a link having one degree of freedom and changing an angle and an auxiliary wheel attached to an end of the link and a front wheel by motor control attached to a body.

Therefore, the present invention may significantly reduce the possibility of personal injury due to falls and safety accidents by unmanned cleaning of the outer wall of high-rise buildings and inspection of large-scale structures through a robot system, and reduce manufacturing and construction costs through use of existing drone systems, and improve reliability.

According to example embodiments, it may remove hassle of management by enabling automation of outer wall cleaning and structure inspection, and prevent large-scale accidents through regular inspection.

The present invention may be applied to various facilities management such as solar maintenance, outer wall cleaning of high-rise buildings, advertisements (signboards) cleanings, and the like, and also applied to inspection of cracks on the outer wall of bridges and large-scale structures.

### BRIEF DESCRIPTION OF THE DRAWINGS

These and/or other aspects, features, and advantages of the present disclosure will become apparent and more readily appreciated from the following description of embodiments, taken in conjunction with the accompanying drawings of which:

FIG. 1 illustrates a configuration of a wall-climbing drone according to an example of embodiments;

FIG. 2 illustrates a free body diagram when attaching a drone to a wall;

FIG. 3 illustrates one example drawing for describing mechanism elements for driving an auxiliary arm and its driving principle;

FIG. 4 illustrates a structure of one example embodiment for sliding mechanism of a battery;

FIG. 5 illustrates one example drawing for describing battery sliding mechanism according to attitude of a drone; and

FIG. 6 illustrates an operation flow chart for a method for controlling a wall-climbing drone according to an example of embodiments.

### DETAILED DESCRIPTION

Advantages, features, and methods of accomplishing the same will become apparatus with reference to embodiments described in detail below together with the accompanying drawings. However, the present invention is not limited by embodiments disclosed hereinafter, and may be implemented in various forms. Rather, these embodiments are provided so that this disclosure will be through and complete and will fully convey the concept of the invention to those skilled in the art, and the present invention will only be defined by the scope of the appended claims.

Terms used in the specification are used to describe embodiments of the present invention and are not intended to limit the scope of the present invention. In the specification, the terms of a singular form may include plural forms unless otherwise specified. The expressions “comprise” and/or “comprising” used herein indicate existence of stated components, steps, operations, and/or elements, but do not exclude presence or addition of one or more other components, steps, operations, and/or elements.

Unless otherwise defined herein, all terms (including technical and scientific terms) used in the specification may have the same meaning that is generally understood by a person skilled in the art. Also, terms which are defined in a dictionary and commonly used should be interpreted as not in an idealized or overly formed detect unless expressly so defined.

Hereinafter, exemplary embodiments of the present invention will be described in detail with reference to the accompanying drawings. The same reference denotations are used for the same components on the drawings, and a duplicated description of the same components will be omitted.

The example embodiments of the present invention have the main idea of easily performing attachment of a wall and movement on a wall by controlling a link angle of an auxiliary arm by using the auxiliary arm including a link having one degree of freedom and changing an angle and an auxiliary wheel attached to an end of the link and a front wheel by motor control attached to a body.

At this time, the present invention may measure a distance between a wall and a drone by using certain sensors, e.g., two ultrasonic sensors, and accordingly, by controlling an angle between an auxiliary arm and a body, an angle with the wall may be maintained in equilibrium.

Moreover, the present invention may maintain balance of the drone by moving location of a battery formed on the other side from the body on which the auxiliary arm is formed according to the attitude of the drone or the angle of the link.

Furthermore, the present invention may estimate gradient of the wall by using the angle of the link, i.e., the angle between the auxiliary arm and the body and the attitude of the drone, and accordingly by controlling propulsion force, maintain attitude on the wall, and climb the wall by using a motor attached to a front wheel.

Furthermore, the present invention may maintain attitude on the wall according to the angle of the link by controlling propulsion force of each propellant according to the angle of the link. Surely, the present invention does not limit to control propulsion force of each propellant according to the angle of the link and the angle of the wall, and may control propulsion force of each propellant by reflecting location of a battery.

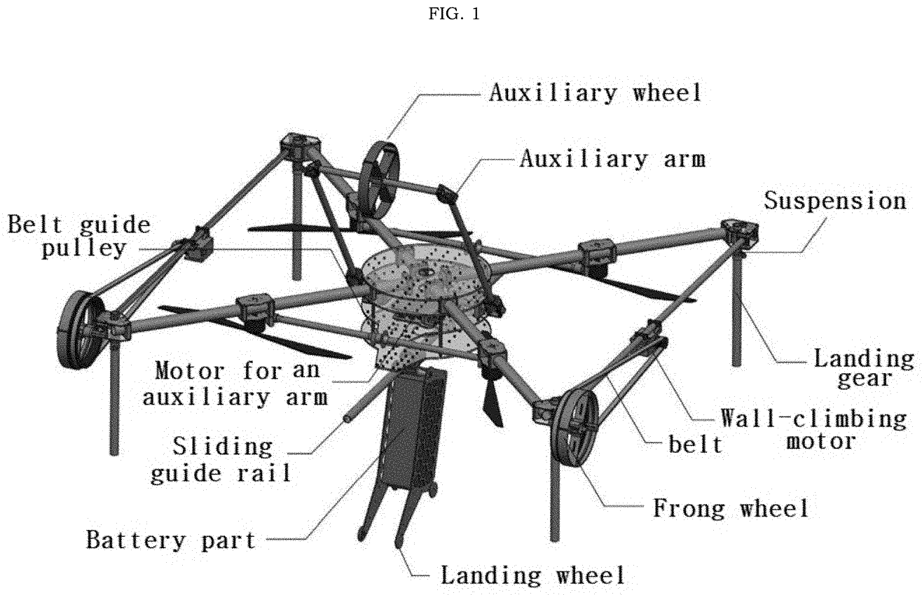

FIG. 1 illustrates a configuration of a wall-climbing drone according to an example of embodiments.

As shown in FIG. 1, a wall-climbing drone according to an example of embodiments may include a front wheel formed on one surface in contact with a wall in a body of the drone and controlled by a motor, an auxiliary arm including a link having one degree of freedom connected to a part of the body, e.g., a central part of the body, and changing an angle and an auxiliary wheel attached to an end of the link, a wall-climbing motor and belt for movement on the wall by controlling rotation of the front wheel, a power transmission system for controlling an angle between the body and the auxiliary arm by controlling power transmission between the body and the auxiliary arm, a battery for providing power to the drone, and a motor for auxiliary arm for controlling rotation of the auxiliary arm as needed.

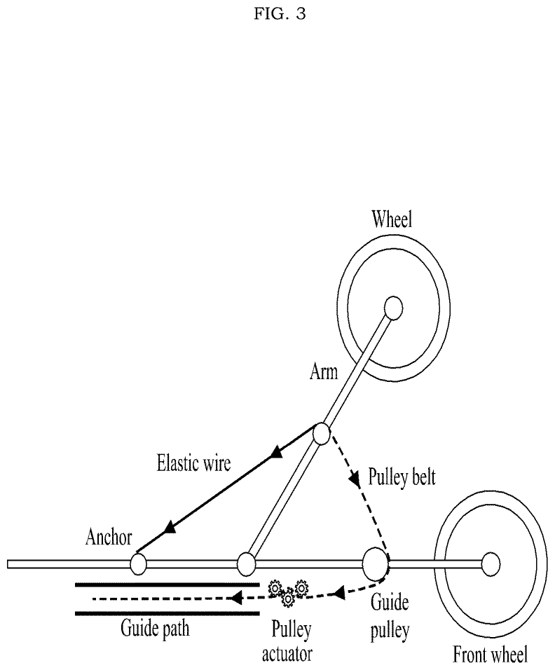

Here, as shown in FIG. 3, the power transmission system may include an elastic wire having a certain elasticity connected between a first anchor of the body and the link of the auxiliary arm, a pulley belt connected with the link and moving through a guide pulley formed at a second anchor of the body; and a pulley actuator controlling an angle between the body and the link by controlling movement direction of the pulley belt.

The pulley actuator may include a lower pulley gear controlled to rotate by the motor and two guide pulley gears moving the pulley belt through a guide pass by the pulley gear, and such pulley actuator may control the angle between the auxiliary arm and the body by being controlled by control means of the drone.

When propulsion force of an unmanned aerial vehicle such as a drone is applied to a wall, friction is generated by normal force, and based on this friction, stable wall movement is possible. However, when friction coefficient of a contact surface is low, since high propulsion force is required to generate friction, it needs to adjust direction of propulsion force.

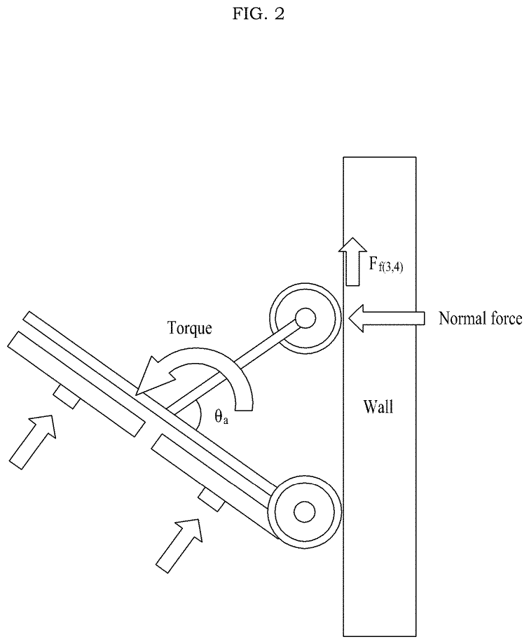

Energy efficiency is optimized by appropriately distributing force to generate friction by applying propulsion force of an aircraft to a wall and force in upward direction which is essential purpose of propellant, and as shown in FIG. 2, the drone of the present invention may simultaneously control attitude of unmanned aerial vehicle, i.e., a drone for the wall by using the auxiliary arm having one degree of freedom and adjust a direction of propellant.

Such present invention may include a lightweight mechanism by considering characteristics of a drone having an extremely limited payload when mounting an auxiliary arm having one degree of freedom, and include a function for optimizing balance of the drone for flight stability.

As shown in FIG. 2, when such drone relies on the auxiliary arm to be attached to the wall, the auxiliary arm receives great force only in opening direction due to reaction against the wall by the direction of propulsion force of the drone.

Therefore, to implement the mechanism in the direction of closing the auxiliary arm with a lightweight material, the present invention may use the power transmission system using tensile force including a pulley belt, a guide pulley, an elastic wire, and a pulley actuator shown in FIG. 3. When a light/small actuator acts in a direction of pulling the pulley belt by control of control means, the auxiliary arm is pulled to a body of an unmanned aerial vehicle, i.e., a drone, and the auxiliary arm rotates in the closed direction.

If this is applied to a rotation shaft of the auxiliary arm with a reduction gear structure, there is an advantage that it can respond to all rotation directions of the auxiliary arm, but in such mechanism, since great force is applied only in a direction in which the auxiliary arm is closed, it may be inefficient, and there may be a disadvantages in that the structure is complicated or the weight increases since a large gear and a plurality of reduction modules are required due to need of a large reduction ratio. Therefore, the present invention may overcome this through a mechanism using the power transmission system based on tensile force shown in FIG. 3.

In addition, since the auxiliary arm is located at the top of the center of gravity of the drone and the front wheel for wall movement is installed on one surface where the drone contacts the wall, it breaks balance of the drone and interferes with stable flight. Therefore, the drone of the present invention acts a counterweight by making location of a battery occupying 40-60% of the weight of the drone automatically be moved according to attitude of the drone or the angle between the auxiliary arm and the body, and through this, it is possible to perform stable flight by maintaining balance of the drone by compensating for balance of the drone broken due to the device for wall movement.

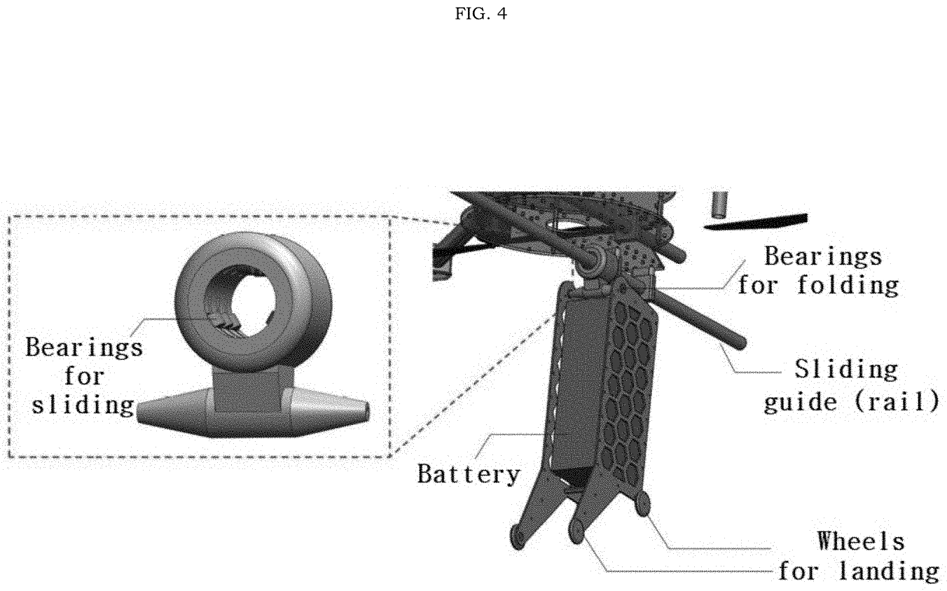

As shown in FIG. 4, such battery may move its location through a sliding guide (or rail), and when the drone comes down to ground from the wall, it may have at least one landing wheel for landing the drone.

At this time, the battery is connected with bearings for sliding for location movement in the sliding guide, and its location may be freely moved in the sliding guide according to attitude of the drone and the angle between the auxiliary arm and the body.

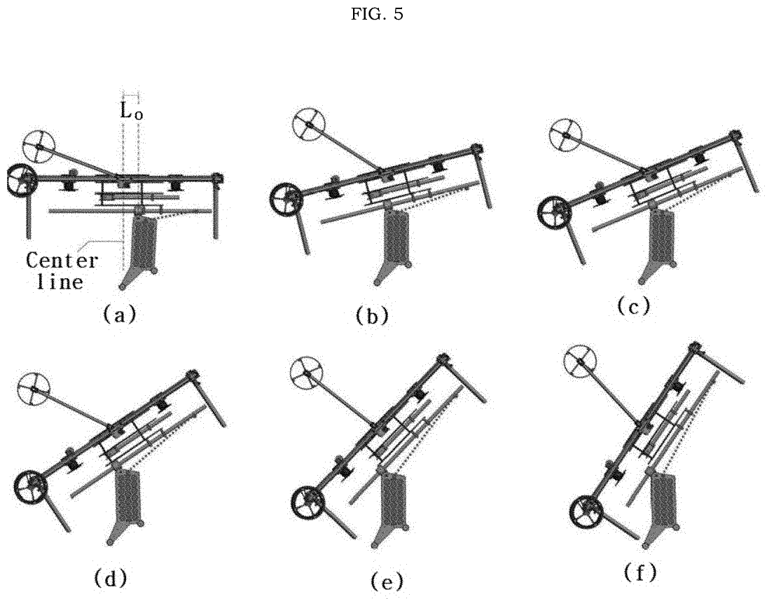

In other words, the battery may facilitate attitude change of the drone by reducing load of propellant for changing attitude by moving the center of gravity to the wall when the drone attaches to the wall and changes its attitude. For example, as shown in FIG. 5, when the drone is moved to the wall, i.e., when the angle between the auxiliary arm and the body increases, as the battery moves to the center of gravity toward the wall by being moved its location toward the front wheel, and on the contrary, when the drone moves away from the wall, i.e., the angle between the auxiliary arm and the body decreases, the battery may maintain the center of gravity of the drone by being moved its location to the direction opposite to the front wheel. The example shown in FIG. 5 is illustrated that the battery is moved through the sliding guide according to the attitude of the drone by connecting the battery with a wire with more than a certain elasticity fixed to the body of the drone, but it is not limited thereto, any method that may automatically move the location of the battery according to the angle between the auxiliary arm and the body may be applied.

For example, by making location movement of the battery to be connected with the pulley actuator shown in FIG. 3, the location of the battery may be automatically moved by the pulley actuator. In other words, when the angle between the body and the auxiliary arm increases by the pulley actuator, by controlling the battery to be moved toward the direction of the front wheel by the rotation direction of the pulley actuator, and when the angle between the body and the auxiliary arm decreases by the pulley actuator, by controlling the battery to be moved toward the director opposite to the front wheel by the rotation direction of the pulley actuator, the center of gravity of the drone may be controlled. Therefore, the present invention may perform power transmission by using the power transmission system including the pulley actuator, as well as perform balance maintenance function through location movement control of the battery.

In the drone of the present invention, the power transmission system is not limited by shown in FIG. 3, and by replacing a first anchor with the guide pulley and implementing the pulley belt to be rotated in a first direction and a second direction through the first anchor and a second anchor, the angle between the auxiliary arm and the body may be controlled by using the pulley actuator. In other words, the power transmission system of the present invention is not limited to the elastic wire, and the power transmission system may be variously implemented by considering lightweight, miniaturization, manufacturing cost, stability, and the like.

In addition, the drone of the present invention may estimate a distance with the wall by using an ultrasonic sensor, but it is not limited thereto, and it may estimate the distance with the wall by using various sensors, For example, the distance between the wall and the body may be estimated through the length of the auxiliary arm and the angle between the auxiliary arm and body.

Also, if an encoder for encoding the angle between the auxiliary arm and the body, e.g., a rotary encoder is equipped, the drone of the present invention may identify the angle between the auxiliary arm and the body by using the corresponding encoder. Furthermore, the present invention may control the angle between the auxiliary arm and the body by using a moter which may control the angle of the auxiliary arm without implementing the power transmission system. In other words, it is most important that the present invention performs wall-climbing by using the auxiliary arm, and all kinds of methods for controlling such auxiliary arm may be applied.

Like this, the wall-climbing drone according to an example of embodiments may easily perform attachment of the wall and movement on the wall by controlling the link angle of the auxiliary arm by using the auxiliary arm including the link having one degree of freedom and changing the angle and the auxiliary wheel attached to the end of the link and the front wheel by the motor control attached to the body.

Therefore, the drone of the present invention may significantly reduce the possibility of personal injury due to falls and safety accidents by unmanned cleaning of the outer wall of high-rise buildings and inspection of large-scale structures through a robot system, and reduce manufacturing and construction costs through use of existing drone systems, and improve reliability.

Also, the wall-climbing drone according to an example of embodiments may remove hassle of management by enabling automation of outer wall cleaning and structure inspection, and prevent large-scale accidents through regular inspection.

Such present invention may be applied to various facilities management such as solar maintenance, outer wall cleaning of high-rise buildings, advertisements (signboards) cleaning, and the like, and also applied to inspection of cracks on the outer wall of bridges and large-scale structures.

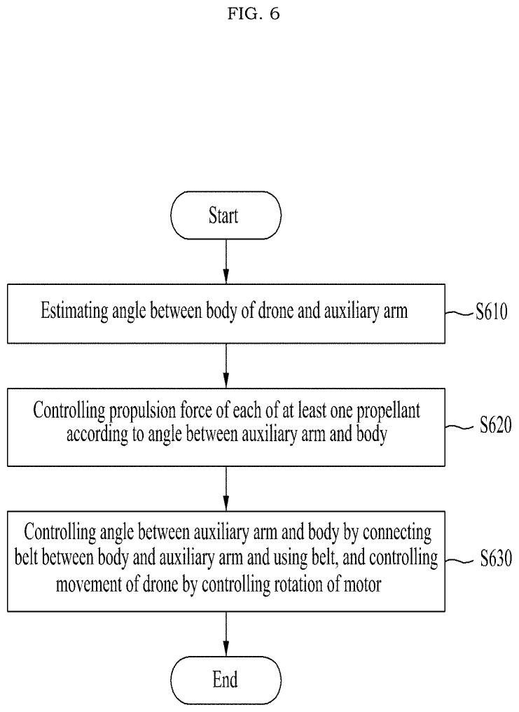

FIG. 6 illustrates an operation flow chart for a method for controlling a wall-climbing drone according to an example of embodiments, and it is about the method for controlling the wall-climbing drone shown in FIGS. 1 to 5.

Referring to FIG. 6, the method for controlling the wall-climbing drone according to an example of embodiments estimates an angle between at least one front wheel for moving the drone on a wall by being attached on one surface of a body in contact with the wall and controlling rotation by a wall-climbing motor and an auxiliary arm including a link having one degree of freedom connected to a part of the body and changing an angle an angle and an auxiliary wheel attached to an end of the link S610.

Here, Step S610 may estimate the corresponding angle by using an encoder for estimating the angle between the body and the auxiliary arm.

If the angle between the body and the auxiliary arm is estimated by Step S610, propulsion force of each of at least one propellant according to the estimated angle is controlled S620.

Here, Step S620 may control propulsion force of each of propellants provided in the drone by considering at least one of the angle between the auxiliary arm and the body, the distance between the body and the wall, gradient of the wall, and location of the battery.

If the drone remains the state attached to the wall through the propulsion force control by Step S620, the angle between the auxiliary arm and the body is controlled by controlling power transmission by connecting a belt between the body and the auxiliary arm and using the belt, and the movement of the drone is controlled by rotating the front wheel by controlling rotation of the motor S630.

Here, Step S630 may control power transmission by using a power transmission system including an elastic wire having a certain elasticity connected between a first anchor of the body and the link (or the auxiliary arm), a pulley belt connected with the link and moving through a guide pulley formed at a second anchor of the body, and a pulley actuator controlling an angle between the body and the link by controlling movement direction of the pulley belt.

Such method of the present invention may maintain balance of the drone by using a battery moving its location according to the angle between the auxiliary arm and the body, and the balance of the drone may be maintained by moving the battery in a direction toward the front wheel as the angle between the auxiliary arm and the body increases, and in a direction opposite to the front wheel as an angle between the auxiliary arm and the body decreases.

Furthermore, the balance of the drone may maintain the balance of the drone by controlling the location movement of the battery by the pulley actuator provided in the power transmission system controlling power transmission.

Although the description is omitted in the method of the present invention, it is clear for those skilled in the art that the method according to the present invention may include all contents described in FIGS. 1 to 5.

The units described herein may be implemented using hardware components, software components, and/or a combination thereof. For example, a processing device may be implemented using one or more general-purpose or special purpose computers, such as, for example, a processor, a controller and an ALU (arithmetic logic unit), a digital signal processor, a microcomputer, a FPGA (field programmable gate array), a PLU (programmable logic unit), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied in any type of machine, component, physical or virtual equipment, computer storage medium or device to provide instructions or data to or be interpreted by the processing device. The software also may be distributed over network coupled computer systems so that the software is stored and executed in a distributed fashion. In particular, the software and data may be stored by one or more computer readable recording mediums.

The method according to the example embodiments may be implemented in a form of program instruction which may be performed through various computer means and recorded in computer-readable media. The media may also include, alone or in combination with the program instructions, data files, data structures, and the like. The media may be continuously storing a program which may be executed with a computer, or temporarily storing for execution or download. Also, the media may be various recording means or storing means in a form of single or a plurality of hardware which are combined, but it is not limited to a media directly accessed to any computer system, and it may be distributed on network. Examples of the media include magnetic media such as hard disks, floppy disks, and magnetic tape; optical media such as CD ROM disks and DVD; magneto-optical media such as floptical disks; and hardware devices that are specially configured to store and perform program instructions, such as ROM (read-only memory), RAM (random access memory), flash memory, and the like. Also, examples of other media include app store distributing applications or recording media and storing media managed in sites, servers, and the like distributing other many software. Examples of program instructions include both machine code, such as produced by a compiler, and higher level code that may be executed by the computer using an interpreter. The hardware apparatus may be configured to operate one or more software modules in order to perform an operation of an embodiment, and vice versa.

While certain example embodiments and implementations have been described herein, other embodiments and modifications will be apparent from this description. Accordingly, the invention is not limited to such embodiments, but rather to the broader scope of the presented claims and various obvious modifications and equivalent arrangements.

1. A wall-climbing drone, comprising:
at least one front wheel for moving a drone on a wall by being attached on one surface of a body in contact with the wall and controlling rotation by a wall-climbing motor;
an auxiliary arm including a link having one degree of freedom connected to a part of the body and changing an angle and an auxiliary wheel attached to an end of the link;
a power transmission system for controlling power transmission by connecting a belt between the body and the auxiliary arm and using the belt; and
a controlling unit for controlling propulsion force of each of at least one propellant according to an angle between the auxiliary arm and the body in a state attached to the wall, controlling power transmission of the power transmission system, and controlling movement of the drone by controlling rotation of the motor.

2. The wall-climbing drone of claim 1, wherein the power transmission system comprises:
an elastic wire having a certain elasticity connected between a first anchor of the body and the link;
a pulley belt connected with the link and moving through a guide pulley formed at a second anchor of the body; and
a pulley actuator controlling an angle between the body and the link by controlling movement direction of the pulley belt.

3. The wall-climbing drone of claim 1, further comprising a battery for providing power to the drone,
wherein the battery is configured to maintain balance of the drone by moving its location according to an angle between the auxiliary arm and the body.

4. The wall-climbing drone of claim 3, wherein the battery is configured to move in a direction toward the front wheel as an angle between the auxiliary arm and the body increases, and move in a direction opposite to the front wheel as an angle between the auxiliary arm and the body decreases.

5. The wall-climbing drone of claim 3, wherein the battery is configured to be formed on a surface opposite to one surface of the body on which the auxiliary arm is formed, and have a landing wheel for landing the drone when the drone comes down to ground.

6. The wall-climbing drone of claim 3, wherein the battery is configured to be moved its location by the pulley actuator, provided in the power transmission system, controlling an angle between the body and the auxiliary arm.

7. A method for controlling a wall-climbing drone, comprising:
estimating an angle between at least one front wheel for moving a drone on a wall by being attached on one surface of a body in contact with the wall and controlling rotation by a wall-climbing motor and an auxiliary arm including a link having one degree of freedom connected to a part of the body and changing an angle and an auxiliary wheel attached to an end of the link;
controlling propulsion force of each of at least one propellant according to an angle between the auxiliary arm and the body; and
controlling an angle between the auxiliary arm and the body by controlling power transmission by connecting a belt between the body and the auxiliary arm and using the belt, and controlling movement of the drone by controlling rotation of the motor.

8. The method for controlling the wall-climbing drone of claim 7, wherein the controlling movement of the drone is configured to control power transmission by using a power transmission system including an elastic wire having a certain elasticity connected between a first anchor of the body and the link, a pulley belt connected with the link and moving through a guide pulley formed at a second anchor of the body, and a pulley actuator controlling an angle between the body and the link by controlling movement direction of the pulley belt.

9. The method for controlling the wall-climbing drone of claim 7, further comprising maintaining balance of the drone by using a battery whose location is moved according to an angle between the auxiliary arm and the body.

10. The method for controlling the wall-climbing drone of claim 9, wherein the maintaining balance of the drone is configured to maintain balance of the drone by moving the battery in a direction toward the front wheel as an angle between the auxiliary arm and the body increases and in a direction opposite to the front wheel as an angle between the auxiliary arm and the body decreases.

11. The method for controlling the wall-climbing drone of claim 9, wherein the maintaining balance of the drone is configured to maintain balance of the drone by moving a location by the pulley actuator, provided in the power transmission system, controlling an angle between the body and the auxiliary arm.

12. A wall-climbing drone, comprising:
at least one front wheel for moving a drone on a wall by being attached on one surface of a body in contact with the wall and controlling rotation by a wall-climbing motor;
an auxiliary arm including a link having one degree of freedom connected to a part of the body and changing an angle and an auxiliary wheel attached to an end of the link;
a power transmission system for controlling power transmission by connecting a belt between the body and the auxiliary arm and using the belt;
a battery for providing power to the drone and maintaining balance of drone by moving its location according to an angle between the auxiliary arm and the body by moving its location in a direction toward the front wheel as an angle between the auxiliary arm and the body increases and in a direction opposite to the front wheel as an angle between the auxiliary arm and the body decreases; and
a controlling unit for controlling propulsion force of each of at least one propellant according to an angle between the auxiliary arm and the body in in a stated attached to the wall, controlling power transmission of the power transmission system, and controlling the movement of the drone by controlling rotation of the motor.
